(19) United States
(12) Patent Application Publication
(10) Pub. No.: US 2008/0147734 A1
(43) Pub. Date: Jun. 19, 2008

(54) Method of topical steroidal organization

(75) Inventors: Charles E. Crutchfield, St. Paul, MN (US); Humberto Gallego, Seattle, WA (US)

Correspondence Address: BRIGGS AND MORGAN P.A., 2200 IDS CENTER, 80 SOUTH 8TH ST, MINNEAPOLIS, MN, 55402, US

(73) Assignee: Cuticeuticals, Inc, St. Paul, MN (US)

(21) Appl. No.: 11/640,660

(22) Filed: Dec. 18, 2006

(51) Int. Cl. G06F 17/30

(52) U.S. Cl. 707/104.1; 707/E17.044

(57) ABSTRACT

A method of organizing and prescribing topical corticosteroids for the treatment of inflammatory skin conditions that creates a nomenclature enabling physicians to readily select appropriate treatment for patients using the name of the topical corticosteroid composition. The invention provides a method for identifying prescription topical corticosteroids using a combination of a product (or trademark) name, topical corticosteroid potency, and formulation vehicle to name prescription topical corticosteroid compositions. This nomenclature generates a family of prescription topical steroid preparations across a range of potency and vehicle formulations that can easily and consistently be identified by the name of the topical steroid composition. The invention also provides a nomenclature for identifying non-prescription topical steroid compositions by combining a common prefix with each vehicle type from non-prescription Group 7 for topical steroids.

### BACKGROUND OF THE INVENTION

The present invention relates to a method of organizing and prescribing topical corticosteroids for the treatment of inflammatory skin conditions. In particular, the invention creates an organizational nomenclature enabling physicians to more readily select appropriate treatment for patients based on the name of the topical corticosteroid composition.

Topical corticosteroids are a powerful tool for treating skin disease. Topical corticosteroids are referred to herein as “corticosteroids” or “glucocorticosteroids” or “topical steroids” in this presentation. Topical corticosteroids are critical components in the treatment of many inflammatory and pruritic (itchy) skin conditions. Topical corticosteroids have potent anti-inflammatory and anti-proliferative effects, and there is a great demand for these agents.

Pharmaceutical companies have responded to the great demand with an increasing number of products. Many topical corticosteroid products are available, and new ones appear almost monthly. There are approximately over 200 different topical corticosteroids to treat inflammatory and pruritic (itchy) skin conditions. Topical corticosteroids have two names, a generic corticosteroid name and a trademark (or product name) of a preparation using the molecule (active ingredient).

With increased potency of topical steroids also comes increased side effects including the development of striae distensae, thinning of the skin, easy bruisability, and development of telangiectasia. Fragility of the skin and bruisability can lead to easy tearing of the skin and recurrent infections. Thus, a medical practitioner (i.e., physician, nurse, pharmacist, medical assistant) faces a balancing act between effectiveness and side effects in selecting and using topical steroids.

Unfortunately for the medical practitioner, neither the generic name nor trademark (or product) name provide, by itself, a well defined relationship to the classifications (or strengths) of prescription topical corticosteroids preparations. In addition, medical practitioner face products (preparations or compositions) coming off patent protection, and marketed as generic versions on a regular basis. One way to identify topical steroid preparations has been to separate the corticosteroids into a category or class based on the potency of the particular composition.

An accepted method of classifying the strength of topical corticosteroid preparations is a seven-level system, in which the levels are often referred to as classes or groups. Hengge et al., “Adverse Effects of Topical Glucocorticosteroids,” Journal of the American Academy of Dermatology, January 2006, pages 1-15, (page 4 contains a detailed Table I with groups and potency). The seven levels are based on an assay measuring the anti-inflammatory properties of the topical corticosteroid, specifically the ability to induce vasoconstriction of the small blood vessels in the upper dermis. The products are subsequently tabulated into one of seven groups based on the assay results, with group I being the strongest and group VII being the weakest (see e.g., Table 1 below identifies two preparations from each class or group).

TABLE 1
Example of Topical steroid Preparations In Each Group

| Group No. | Generic Name | Brand Names |
|---|---|---|
| I | Clobetasol propionate, ointment, cream 0.05%; | Temovate, Dermoxin |
| | Halobetasol proprionate, ointment, cream 0.05%; | Ultravate |
| II | Amcinonide, ointment, .01% | Cyclocort |
| | Halcinonide, cream, 0.1% | Halog |
| III | Triamcinolone acetonide, cream 0.5% | Aristocort HP |
| | Halcinonide, ointment, 0.1% | Halog |
| IV | Fluocinolone acetonide, ointment 0.025% | Synalor |
| | Halcinonide, ointment, 0.025% | Halog |
| V | Hydrocortisone valerate, cream, 0.2% | Westcort |
| | Triamcinolone acetonide, lotion 0.1% | Kenalog |
| VI | Desonide, cream, 0.05% | Desown, Tridesilon |
| | Triamcinolone acetonide, cream 0.1% | Aristocort |
| VII | Hydrocortisone, 0.5%, 1%, 2.5% | Hytone, others |
| | Methylprednisolone, 1% | Medrol |

### The Hengge et al article lists several corticosteroid preparations in each group, treatment guidelines, and adverse effects; this article is incorporated by reference herein in its entirety.

Treatment recommendations for use of topical steroids can be by group number, rather than by generic or brand name, because the agents in each group are essentially equivalent in strength. The potency of a particular corticosteroid is an important factor in the selection of a proper agent. The best results for patients are typically obtained when preparations of adequate strength are used for a specified length of time. The practitioner balances that concern against using weaker, “safer” strengths but which often fail to provide adequate control.

In addition to the potency of a topical corticosteroid, the medical practitioner considers the patient's age, vehicle formulation (or “vehicle”), anatomical location of the body part in need of treatment, the side effects, the necessity of using the topical steroid for long or short term, and other factors in selecting a corticosteroid preparation. For example, lower potency agents are often used with infants and the elderly because of concerns about an increased surface-to-weight ratio and increased skin fragility.

The medical practitioner considers the vehicle formulation in selecting a topical steroid preparation. For example, when the skin is very dry and cracked or if the skin is abraded, a topical corticosteroid ointment can be preferred as the vehicle formulation. Ointment vehicles enhance penetration of the drug by means of their occlusive effect and increase in hydration of the stratum corneum. Creams can be used as the vehicle when a patient does not like the greasy feel of an ointment, and often the skin is normal to a little bit dry. Creams are preferred for acute and subacute dermatoses and on moist skin or intertriginous areas. Lotions can be used as a vehicle when the skin is normal, as lotions tend to plug up the pores of the skin less than ointments and creams. Solutions are more drying, and usually contain alcohol. Solutions can be used when the skin is oily. Gels are even more drying than solutions. For example, in an oozing skin condition like poison ivy, a gel can help relieve the poison ivy reaction, and dry the skin to improve the oozing condition.

In view of the plethora of topical steroids, a medical practitioner would need to memorize hundreds of topical steroids, and remember what class the topical steroid falls into to improve selection of an agent. This is a daunting task for medical practitioners. As a result, many physicians use a few corticosteroids, and subsequently limit their ability to prescribe the most appropriate topical steroid. There is no easy and effective method or organization available for improving the selection of a topical steroid.

There exists a need for a system of organization for topical corticosteroids that enables a medical practitioner to select (or prescribe) the appropriate topical steroid without having to resort to memorizing hundreds of topical steroids, and obtain the appropriate potency and formulation vehicle with greater ease and efficiency.

### SUMMARY OF THE INVENTION

A method of organizing and prescribing topical corticosteroids for the treatment of inflammatory skin conditions is the invention. This method creates a nomenclature enabling physicians to easily select appropriate treatment for patients using the name of the topical corticosteroid composition. This method eliminates the need for memorization and differentiation among the hundreds of topical steroid products available in the market. This method is user friendly for the medical practitioner.

The method for organizing and identifying prescription topical corticosteroids uses a combination of a product (or trademark) name, topical corticosteroid potency, and formulation vehicle in naming prescription topical corticosteroid compositions. This nomenclature generates a family of prescription topical steroid preparations across a range of potency and vehicle formulations that are easily and consistently identified by the name of the prescription topical steroid composition. The invention also provides a nomenclature for organizing and identifying non-prescription topical steroid compositions by combining a common prefix with each vehicle formulation for the non-prescription (also referred to as “group 7” or “Over the Counter”) topical steroids.

### BRIEF DESCRIPTION OF THE DRAWINGS

FIG. 1 shows an example of the organization structure and nomenclature of the invention in a chart format.

FIG. 2 shows a chart listing the accepted medical grouping of topical steroids into seven classes or groups.

### DETAILED DESCRIPTION OF THE PREFERRED EMBODIMENT

To date, there is no simplified system to help doctors understand and prescribe the correct medicine for topical application without investing significant time for each branded topical steroid product. In addition, many branded products (on patent) can be expensive and prohibitive in cost for some patients. The costs of detailing products to medical professionals is a significant expense.

The system of the present invention offers a solution to these difficulties by providing a unified system of organization for the potency range of topical steroids and vehicle formulation. The system is easily understood by doctors, and allows for use of generic drugs (under the nomenclature and organization of the invention). The cost savings of using generic drugs, and a single (in lieu of several) pharmaceutical sales representative to detail the system can be passed along to the patient.

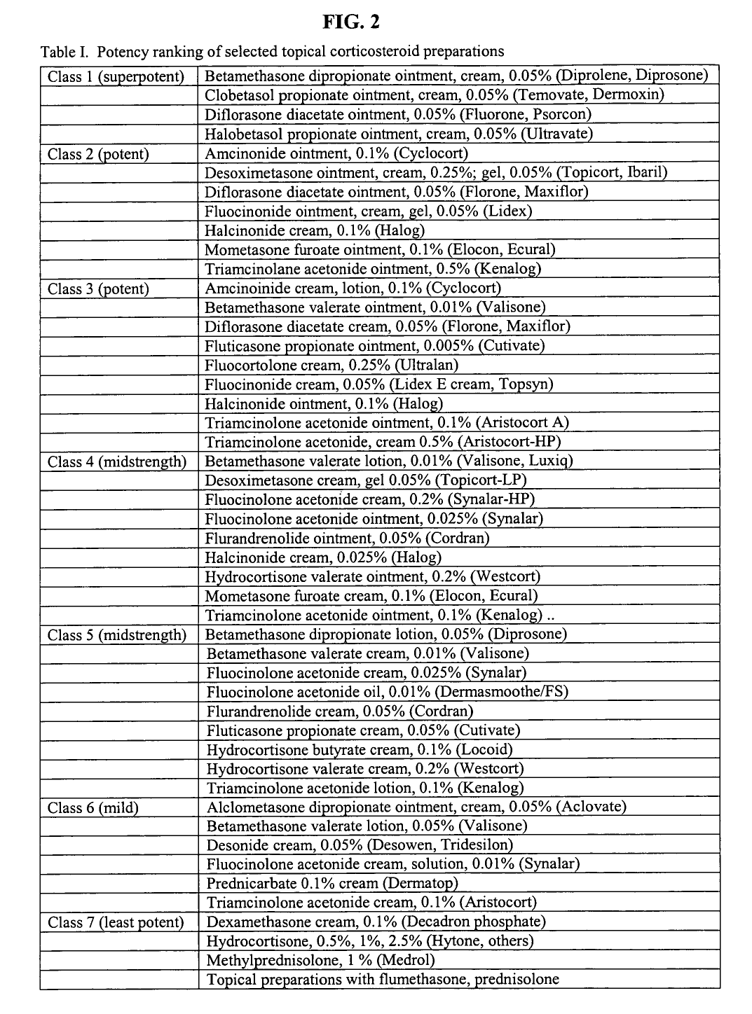

The present invention creates an effective method of organizing topical steroids that has significant benefits. The invention involves the use of a product name, such as trademark or product name, combined with a topical steroid class, such as the medically accepted seven grouping of topical steroids, and also includes the vehicle formulation. A detailed chart showing preparations under each grouping is provided. In FIG. 2, the table is derived from the information on page 4 of Hengge et al., “Adverse Effects of Topical Glucocorticosteroids,” Journal of the American Academy of Dermatology, January 2006.

The present invention enables a doctor to prescribe a topical corticosteroid to a patient without having to memorize hundreds of different products. After an examination of a patient in need of treatment, the doctor considers at least two things necessary for selecting an appropriate topical steroid: 1) the class (potency) and 2) vehicle formulation for the particular patient or skin condition. Armed with this knowledge, the doctor can readily determine and write a prescription for the patient using the present invention or select an appropriate non-prescription preparation.

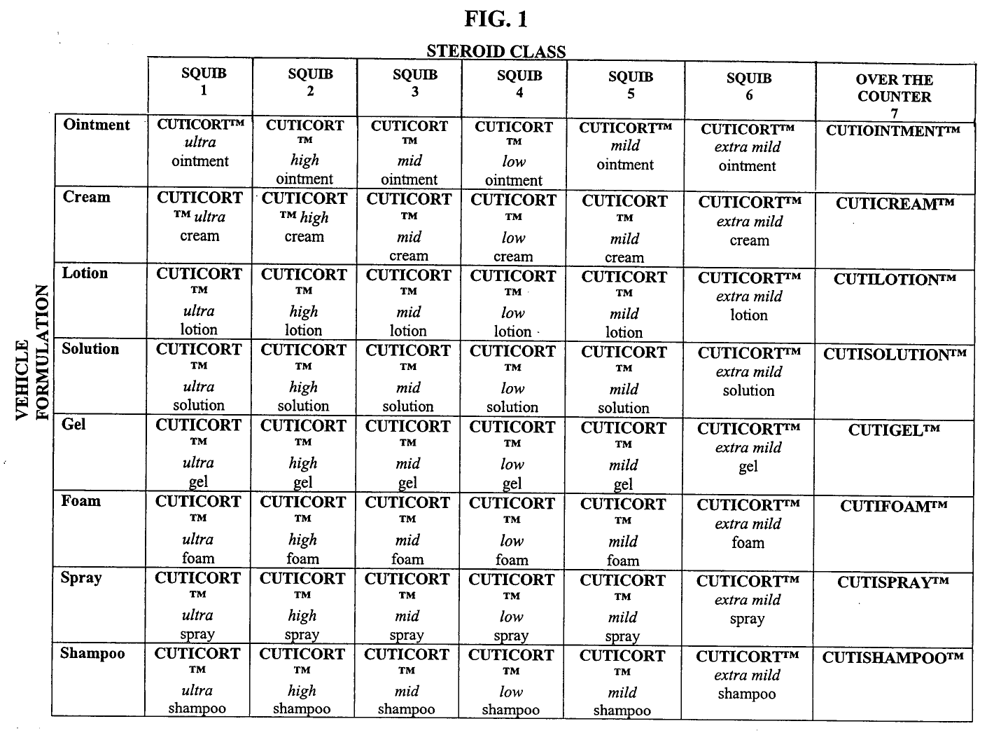

An embodiment of the invention, a prospective example, is shown in FIG. 1. In this embodiment, the product name (trademark) is “CUTICORT™.” The seven level grouping of the topical prescription topical steroid classes are shown as: SQUIB 1 through SQUIB 6, and “Over The Counter” (non-prescription, class 7). As used in this application, “SQUIB” is a short name for prescription. The seven groupings shown in FIG. 1 are equivalent to Groups 1-7 (described above), with the highest prescription potency as SQUIB 1 and decreases in lowest prescription potency to SQUIB 6, and Over The Counter, non-prescription, group 7 (weakest).

For an example of use of this method, a doctor familiar with the nomenclature and organization of the invention (embodiment shown in FIG. 1) knows that “CUTICORT™ brand of topical steroids uses potency and formulation in its naming protocol for prescription topical steroids, Groups 1-6 (above), and FIG. 2. Moreover, the doctor knows that CUTICORT™ is a single name (brand or product name) used to identify a plurality of corticosteroid compositions. With this knowledge, the doctor can select the potency and vehicle formulation for a patient by simply choosing “CUTICORT™+potency+vehicle” resulting in the name “CUTICORT™ ultra spray.” If the need is for a group 3 topical steroid lotion, the doctor selects CUTICORT™+ mid (corresponds to group 3)+lotion by writing a prescription for CUTICORT™ mid lotion.”

In FIG. 1, the trademark name of the prescription product uses CUTICORT™, and the horizontal position of the chart lists the classes as SQUIB 1 through the Over The Counter (“Group 7,” or “non-prescription”), and the vertical position of the chart lists the following vehicle formulations: ointment, cream, lotion, solution, gel, foam, and spray. In this embodiment, the following designations are used as equivalent to the grouping as follows:
a) SQUIB 1 contains a topical steroid preparation selected from Group 1 (see FIG. 2 for topical steroid preparations), and uses “ultra” to designate preparation comes from Group 1;
b) SQUIB 2 contains a topical steroid preparation selected from Group 2 (see FIG. 2 for topical steroid preparations), and uses “high” to designate preparation comes from Group 2;
c) SQUIB 3 contains a topical steroid preparation selected from Group 3 (see FIG. 2 for topical steroid preparations), and uses “mid” to designate preparation comes from Group 3;
d) SQUIB 4 contains a topical steroid preparation selected from Group 4 (see FIG. 2 for topical steroid preparations), and uses “low” to designate preparation comes from Group 4;
e) SQUIB 5 contains a topical steroid preparation selected from Group 5 (see FIG. 2 for topical steroid preparations), and uses “mild” to designate preparation comes from Group 5;
f) SQUIB 6 contains a topical steroid preparation selected from Group 6 (see FIG. 2 for topical steroid preparations), and uses “extra mild” to designate preparation comes from Group 6; and
g) Over The Counter (Group 7) contains non-prescription topical steroid preparations.

As shown in FIG. 1, the present invention combines the trademark, the potency, and the vehicle formulation to create an easily identifiable method of organizing topical steroid preparations for ease in prescribing a particular product. For example, if a medical practitioner wants the highest potency topical steroid in a lotion, the physician can write a prescription for CUTICORT™ ultra lotion.

The physician can choose among a variety of vehicle formulations for the “ultra” (or GROUP 1) by using the nomenclature of product name+potency+vehicle such as: CUTICORT™ ultra ointment, CUTICORT™ ultra cream, CUTICORT™ ultra ointment, CUTICORT™ ultra solution, CUTICORT™ ultra gel, as CUTICORT™ ultra foam, as CUTICORT™ ultra spray, and CUTICORT™ ultra shampoo. See FIG. 1. This nomenclature is consistent for all of the prescription groups.

While not shown in FIG. 1, the invention envisions that the potency and vehicle formulation can be in a written form that precedes the trademark name, or is after the trademark name, or where the trademark name is between the potency and the vehicle formulation. For example, the nomenclature envisions “CUTICORT™ ultra spray,” or “CUTICORT™ spray ultra,” or “Ultra CUTICORT™ spray” or “ultra spray CUTICORT™” as being consistent with the invention. Whatever form of the nomenclature is used, that form needs to be used in a consistent manner. For example, if the nomenclature is “CUTICORT™ ultra spray,” then the remaining preparations should use the same naming format (i.e. “CUTICORT™ ultra gel,”). This organizational structure of the invention enables medical practitioners to easily select the appropriate agent (“preparation or composition”).

Another prospective embodiment involves using the group numbers in naming the topical steroid preparation, such as CUTICORT™ Group 1 ointment, CUTICORT™ Group 2 ointment, and CUTICORT™ Group 3 ointment. Thus, like prior examples, the nomenclature would be consistent across the range of potency and vehicle formulation combined with the trademark name.

The embodiment in FIG. 1, for the Over The Counter, non-prescription, group 7, does not readily correspond to the nomenclature or organization of the invention for prescription topical steroids. However, the Group 7 (“non-prescription” or Over the Counter”) products have a similar nomenclature aimed for the target consumers, users of non-prescription products, and physician recommendations of non-prescription agents. The nomenclature involves: selecting a prefix that identifies the Group 7 non-prescription corticosteroid compositions; selecting the vehicle formulation for non prescription corticosteroid composition from the group consisting of ointment, cream, lotion, solution, foam, spray, and shampoo; and combining the prefix and vehicle formulation to create a non-prescription corticosteroid composition single word name.

For example in FIG. 1, the nomenclature for non-prescription agents are identified in a single name as: “CUTILOTION™,” CUTIOINTMENT™, CUTICREAM™, CUTISOLUTION™, CUTIGEL™, CUTIFOAM™, CUTISPRAY™, and CUTISHAMPOO™. An alternate single name, envisioned by this disclosure, and as shown in the following examples would be: CUTI-LOTION, and CUTI-CREAM using a hyphenated single name.

A benefit of this invention is that a group of topical steroid preparations can be created under a single product name that helps lower costs in healthcare system. In this situation, the user selects topical steroid preparations that are generic drugs (not under patent protection), and uses the method or system of the invention to create a family of topical generic drug formulations under a brand name. As there are several topical steroids under each of the seven groupings discussed above (See FIG. 2), a user can select between different generic drugs (not the same active ingredient) while using a consistent nomenclature and potency (based on the seven categories).

While the above discussion used the seven group potency classification, the invention contemplates that equivalent group names such as a five class range (to four and three classes) to describe the potency. For example, in FIG. 2, the categories can also be separated into five groups such as:

1) Superpotent (Class 1 in chart);

2) Potent (Classes 2-3 in chart);

3) Midstrength (Classes 4-5 in chart);

4) Mild (Class 6 in chart); and

5) Least Potent (Class 7 in chart).

As can be expected, the seven group potency classification provides the greatest range of treatment, and would be a preferred embodiment. The five group potency classification (as shown above) would be a preferred embodiment. A six group potency classification would be a preferred embodiment assuming that there is a readily identifiable (and acceptable) grouping like the seven and five groups. As the range of potency classes is reduced from the seven (and five) accepted medical groups for topical steroid to lesser groups down to three or four, the system becomes more inflexible, and loses some of the benefits of the invention.

Another benefit of the invention is that a single pharmaceutical representative can detail and educate physicians on use of the topical steroid created in accordance with the invention. Topical steroids come in numerous names and brands. A doctor must see several different representatives and remember numerous brand names from each. This is inefficient and cumbersome. The system of the invention for topical steroid products can be described in a simple, brief, and easily understandable discussion. Indeed, the sales representative can provide a simple chart, such as shown in FIG. 1, that can be used without immediate memorization.

The present invention may be embodied in other specific forms without departing from the spirit or essential attributes thereof, and it is therefore desired that the present embodiment be considered in all respects as illustrative and not restrictive.

What is claimed:

1. A system of organization for corticosteroids using the potency classification of a corticosteroid and vehicle formulation in naming a corticosteroid product, and enabling a person to select the corticosteroid product for a patient based on the potency and vehicle formulation in the name, comprising the steps of:
a) selecting a single name to identify a plurality of prescription corticosteroid compositions;
b) selecting the potency classification for the prescription corticosteroid composition from the group consisting of ultra, high, mid, low, mild, and extra mild;
c) selecting the vehicle formulation for the prescription corticosteroid composition from the group consisting of ointment, cream, lotion, solution, foam, spray, and shampoo;
d) combining the single name from step a), the potency classification from step b) and the vehicle formulation from step c) to create the product name for the prescription corticosteroid composition; and
e) repeating steps a-d until there are at least three product names, and each product name having a different potency classification.

2. The system of claim 1 wherein repeating step e) until there are four product names, and each product name having a different potency classification

3. The system of claim 1 wherein the step of repeating step e) until there are five product names, and each product name having a different potency classification

4. The system of claim 1 wherein the step of repeating step e) until there are six product names, and each product name having a different potency classification.

5. The system of claim 1 further comprising the steps of:
f) selecting a prefix that identifies Group 7 non-prescription corticosteroid compositions; and
g) selecting the vehicle formulation for non prescription corticosteroid composition from the group consisting of ointment, cream, lotion, solution, foam, spray, and shampoo; and
h) combining the prefix to the vehicle formulation selected from step g) to create a non-prescription corticosteroid composition having the vehicle formulation in a single name.

6. The system of claim 2 further comprising the steps of:
f) selecting a prefix that identifies Group 7 non-prescription corticosteroid compositions; and
g) selecting the vehicle formulation for non prescription corticosteroid composition from the group consisting of ointment, cream, lotion, solution, foam, spray, and shampoo; and
h) combining the prefix to the vehicle formulation selected from step g) to create a non-prescription corticosteroid composition having the vehicle formulation in a single name.

7. The system of claim 3 further comprising the steps of:
f) selecting a prefix that identifies Group 7 non-prescription corticosteroid compositions; and
g) selecting the vehicle formulation for non prescription corticosteroid composition from the group consisting of ointment, cream, lotion, solution, foam, spray, and shampoo; and
h) combining the prefix to the vehicle formulation selected from step g) to create a non-prescription corticosteroid composition having the vehicle formulation in a single name.

8. The system of claim 4 further comprising the steps of:
f) selecting a prefix that identifies Group 7 non-prescription corticosteroid compositions; and
g) selecting the vehicle formulation for non prescription corticosteroid composition from the group consisting of ointment, cream, lotion, solution, foam, spray, and shampoo; and
h) combining the prefix to the vehicle formulation selected from step g) to create a non-prescription corticosteroid composition having the vehicle formulation in a single name.

9. The system of claim 1 further comprising the step of selecting the appropriate medical treatment for the patient using the potency and vehicle formulation information identified in the product name of said corticosteroid compositions.

10. The system of claim 2 further comprising the step of selecting the appropriate medical treatment for the patient using the potency and vehicle formulation information identified in the product name of said prescription corticosteroid compositions.

11. The system of claim 3 further comprising the step of selecting the appropriate medical treatment for the patient using the potency and vehicle formulation information identified in the product name of said prescription corticosteroid compositions.

12. The system of claim 4 further comprising the step of selecting the appropriate medical treatment for the patient using the potency and vehicle formulation information identified in the product name of said prescription corticosteroid compositions.

13. A system of organization for corticosteroids using the potency classification of a corticosteroid and vehicle formulation in naming a corticosteroid product, and enabling a person to select the corticosteroid product for a patient based on the potency and vehicle formulation in the name, comprising the steps of:
a) selecting a single name to identify a plurality of prescription corticosteroid compositions;
b) selecting the potency classification for the prescription corticosteroid composition from the group consisting of superpotent, potent, midstrength; mild, and least potent;
c) selecting the vehicle formulation for the prescription corticosteroid composition from the group consisting of ointment, cream, lotion, solution, foam, spray, and shampoo;
d) combining the single name from step a), the potency classification from step b) and the vehicle formulation from step c) to create the product name for the corticosteroid composition; and
e) repeating step a-d until there are at least five product names, and each product name having a different potency classification.

14. A system of organization for corticosteroids using the potency classification of a corticosteroid and vehicle formulation in naming a corticosteroid product, and enabling a person to select the corticosteroid product for a patient based on the potency and vehicle formulation in the name, comprising the steps of:
a) selecting a single name to identify a plurality of prescription corticosteroid compositions;
b) organizing corticosteroids to identify at least one corticosteroid composition in each of the following potency classifications: ultra, high, mid, low, mild, and extra mild;
c) organizing corticosteroids identified by potency classification in step b) to include at least one of the following vehicle formulations: ointment, cream, lotion, solution, foam, spray, and shampoo for each corticosteroid classification;
d) identifying the single name from step a), the potency classification and vehicle formulation from step c), to create product names for each corticosteroid composition;
e) selecting a prefix that identifies Group 7 non-prescription corticosteroid compositions; and
f) organizing the non prescription corticosteroid compositions to include each of following vehicle formulations: ointment, cream, lotion, solution, foam, spray, and shampoo; and
g) combining the prefix to the vehicle formulation selected from step e) to each of the vehicle formulations from step f) to create a single product name for each non-prescription corticosteroid composition.
